(19) United States
(12) Patent Application Publication
(10) Pub. No.: US 2013/0057105 A1
(43) Pub. Date: Mar. 7, 2013

(54) PERMANENT MAGNET MOTORS AND METHODS OF ASSEMBLING THE SAME

(71) Applicants: Dean James Patterson, Murwillumbah (AU); Steven Stretz, Wausau, WI (US); William Stadler, Wausau, WI (US); Alan W. Yeadon, Wausau, WI (US)

(72) Inventors: Dean James Patterson, Murwillumbah (AU); Steven Stretz, Wausau, WI (US); William Stadler, Wausau, WI (US); Alan W. Yeadon, Wausau, WI (US)

(21) Appl. No.: 13/224,834

(22) Filed: Sep. 2, 2011

(51) Int. Cl. H02K 1/27; H02K 15/02

(52) U.S. Cl. 310/156.53; 29/598

(57) ABSTRACT

A method for manufacturing an interior permanent magnet motor is described herein. The method includes providing a plurality of permanent magnets and fabricating a ferromagnetic rotor core configured to accept the permanent magnets therein such that the ferromagnetic material utilized to retain the permanent magnets within the rotor core operates to concentrate and steer the flux from one or more of the permanent magnets to a stator tooth. The method also includes positioning the rotor core with the permanent magnets therein with respect to a wound, open slot stator core.

### BACKGROUND

This disclosure relates generally to permanent magnet rotor motors, and more particularly, to methods and systems for reducing noise and cogging torque in motors incorporating a permanent magnet rotor.

Certain permanent magnet rotor motors are sometimes referred to as brushless motors. Brushless motors include both brushless AC motors and brushless DC motors. Brushless motors are used in a wide variety of systems operating in a wide variety of industries. As such, the brushless motors are subject to many operating conditions. In such a motor, the torque resulting from the magnetic interaction between the rotor and stator may contain an undesirable torsional ripple, either resulting from the current in the windings, or simply from the interaction of the permanent magnets and the stator, present in an unpowered machine, which is known as detent or cogging torque. In addition, there may be radial forces between the rotor and stator which cause objectionable noise.

More specifically, the passing of the rotor magnets through the open area between stator teeth, coupled with the attraction to and repulsion from the solid teeth of the stator causes vibration, cogging torque, torque pulsation and potentially motor noise, an amount of which may be objectionable to a user. Audible motor noise is unacceptable in many applications. Further, the cogging and the torque pulses at the shaft of the motor may be transmitted onto a fan, blower assembly or other driven equipment/end device that is attached to the shaft. In such applications these torque pulses and the effects of cogging may result in operational issues and/or acoustical noise that can be objectionable to an end user of the motor.

Semi-closed stator slots that include tooth extensions at the stator bore may counteract the torsional ripple. The tooth extensions serve the primary purpose of improving the effective flux coupling between the rotor and the stator and may lower the cogging torque in a permanent magnet machine. However, semi-closed stator slots typically increase the complexity and expense of coil winding machinery. Even so, the operational benefits of stator tooth extensions and the resulting semi-closed stator slots have led to continued manufacturing of such motors.

In summary, semi-closed stator slots, rather than fully open stator slots, can be used to reduce noise and improve performance and operate to essentially widen the magnetic poles or minimize the openings between each stator tooth. However, stators that incorporate semi-closed slots are more difficult to fabricate, and the area available for the copper wire windings that can be inserted or wound into such slots is limited. As such, open slot or nearly open slot stators are preferred for manufacturing reasons, as the wire for the windings can be inserted into the slots with greater ease.

A permanent magnet rotor may include permanent magnets embedded within a rotor core. Such a rotor may be referred to as an interior permanent magnet rotor. Slots are formed within the rotor core and magnets are inserted into the slots. Positioning the permanent magnets close to the outer surface of the rotor core increases motor performance. However, the rotor core must be configured to provide adequate mechanical support for the permanent magnets. The magnets, as well as the surrounding structures, are subject to various forces arising from thermal expansion, rotation, and residual forces caused by the manufacturing process, such as distortion due to welding.

### BRIEF DESCRIPTION

In one aspect, a method for manufacturing an interior permanent magnet motor is provided. The method includes providing a plurality of permanent magnets, fabricating a ferromagnetic rotor core configured to accept the permanent magnets therein such that the ferromagnetic material utilized to retain the magnets within the rotor core operates to concentrate and steer the flux from one or more of the magnets to a stator tooth, and positioning the rotor core with the magnets therein with respect to a wound, open slot stator core.

In another aspect, a motor is provided. The motor includes a shaft, a permanent magnet rotor, and a stator assembly. The permanent magnet rotor includes a central bore through which the shaft extends, a plurality of permanent magnets, and a rotor core configured to accept the permanent magnets therein defining a number of rotor poles. The rotor core includes a ferromagnetic material operable to retain the magnets within the rotor core. The stator assembly includes an open slot stator core having a plurality of slots and teeth The ferromagnetic material within the rotor core is configured to concentrate and steer the flux from one or more of the magnets to a tooth of the stator assembly proximate the ferromagnetic material.

In still another aspect, an interior permanent magnet rotor is provided that includes a plurality of permanent magnets and a rotor core configured to accept the permanent magnets therein, thereby defining a number of rotor poles. The rotor core includes a ferromagnetic material operable to retain the magnets within the rotor core and concentrate and steer flux from one or more of the magnets to a tooth of a stator assembly.

### BRIEF DESCRIPTION OF THE DRAWINGS

FIG. 1 is an exploded cutaway view of an exemplary electric motor.

FIG. 2 is a front cutaway view of an exemplary embodiment of a rotor core that may be included within the electric motor shown in FIG. 1.

FIG. 3 is a front view of an alternative rotor core that may be included within the electric motor shown in FIG. 1.

FIG. 4 is a detailed view of an open slot stator including a stator core and the windings associated therewith.

FIG. 5 is a detailed view of a portion of a stator that includes a stator core, windings, and a semi-magnetic wedge between the individual teeth of the stator.

FIG. 6 illustrates a full stator incorporating the wedges as described with respect to FIG. 5.

FIG. 7 is a cross-sectional view of a skewed stator stack illustrating the semi-magnetic wedge placed between the teeth formed by the skewed stack.

FIG. 8 is an illustration of an interior permanent magnet rotor operably placed with respect to a stator.

FIG. 9 is a front view of a ten pole rotor positioned with respect to a twelve pole stator.

### DETAILED DESCRIPTION

Torque generated by the magnetic interaction between a rotor and a stator may contain an undesirable cogging and/or commutation torque component that may be transmitted to the motor shaft, and then to a work component, possibly resulting in objectionable acoustical noise and vibration. Furthermore, radial forces on a rotor within a motor containing an open slot stator may also cause objectionable noise. Described herein are methods and systems related to determining a stator skew based on the number of stator teeth/slots and rotor poles, configuring an interior permanent magnet rotor, and positioning of a magnetic or semi-magnetic wedge between the skewed stator teeth. These methods and systems improve motor performance and/or reduce noise and vibration.

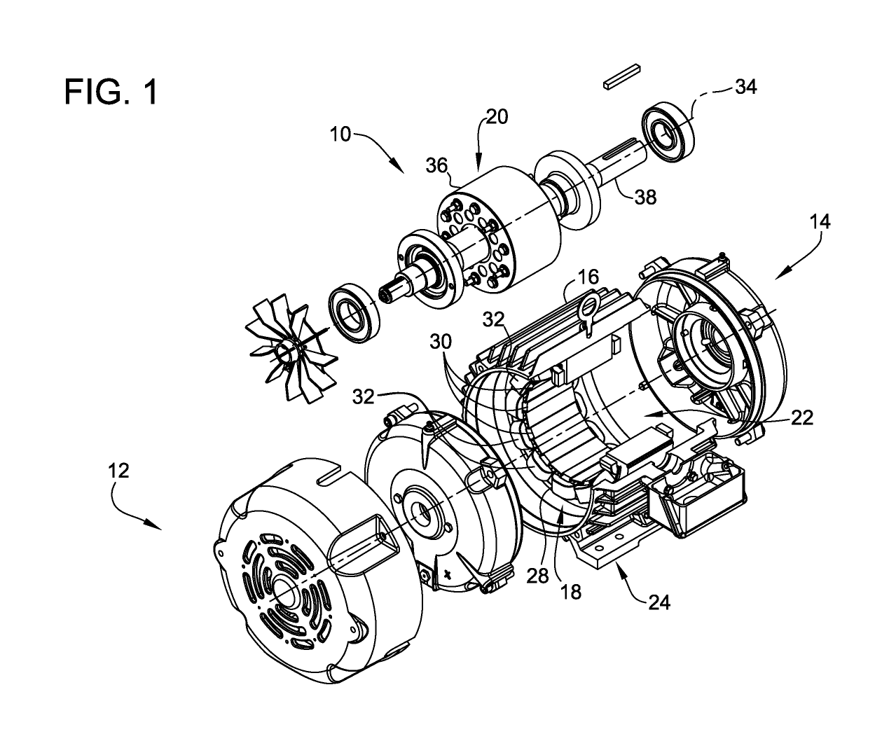

FIG. 1 is an exploded cutaway view of an exemplary electric machine 10. Although electric machine 10 is referred to herein as an electric motor, electric machine 10 can be operated as either a generator or a motor. Electric motor 10 includes a first end 12 and a second end 14. Electric motor 10 further includes a motor assembly housing 16, a stationary assembly 18, and a rotatable assembly 20. Motor assembly housing 16 defines an interior 22 and an exterior 24 of motor 10 and is configured to at least partially enclose and protect stationary assembly 18 and rotatable assembly 20. Stationary assembly 18 includes a stator core 28, which includes a plurality of stator teeth 30 and a plurality of winding stages 32 wound around stator teeth 30 and adapted to be electronically energized to generate an electromagnetic field. In the exemplary embodiment, a variable frequency drive (not shown in FIG. 1) provides a signal, for example, a pulse width modulated (PWM) signal, to electric motor 10. In an alternative embodiment, electric motor 10 may include a controller (not shown in FIG. 1) coupled to winding stages 32 and configured to apply a voltage to one or more of winding stages 32 at a time for commutating winding stages 32 in a preselected sequence to rotate rotatable assembly 20 about an axis of rotation 34.

In an exemplary embodiment, stationary assembly 18 is a three phase concentrated wound stator assembly and stator core 28 is formed from a stack of laminations made of a highly magnetically permeable material. Winding stages 32 are wound on stator core 28 in a manner known to those of ordinary skill in the art. While stationary assembly 18 is illustrated for purposes of disclosure, it is contemplated that other stationary assemblies of various other constructions having different shapes and with different numbers of teeth may be utilized within the scope of the invention so as to meet at least some of the objects thereof.

Rotatable assembly 20 includes a permanent magnet rotor core 36 and a shaft 38. In the exemplary embodiment, rotor core 36 is formed from a stack of laminations made of a magnetically permeable material and is substantially received in a central bore of stator core 28. Rotor core 36 may be formed of soft ferromagnetic material. Rotor core 36 and stator core 28 are illustrated as being solid in FIG. 1 for simplicity, their construction being well known to those of ordinary skill in the art. While FIG. 1 is an illustration of a three phase electric motor, the methods and apparatus described herein may be included within motors having any number of phases, including single phase and multiple phase electric motors.

In the exemplary embodiment, electric motor 10 is coupled to a work component (not shown in FIG. 1) included within a commercial and/or industrial application. The work component may include, but is not limited to, a pump system, an air handling unit, and/or manufacturing machinery (e.g., conveyors and/or presses). In such applications, motor 10 may be rated at, for example only, three horsepower (hp) to sixty hp. In an alternative embodiment, the work component may include a fan for moving air through an air handling system, for blowing air over cooling coils, and/or for driving a compressor within an air conditioning/refrigeration system. More specifically, motor 10 may be used in air moving applications used in the heating, ventilation, and air conditioning (HVAC) industry, for example, in residential applications using ⅓ horsepower (hp) to 1 hp motors. Although described herein using the above examples, electric motor 10 may engage any suitable work component and be configured to drive such a work component.

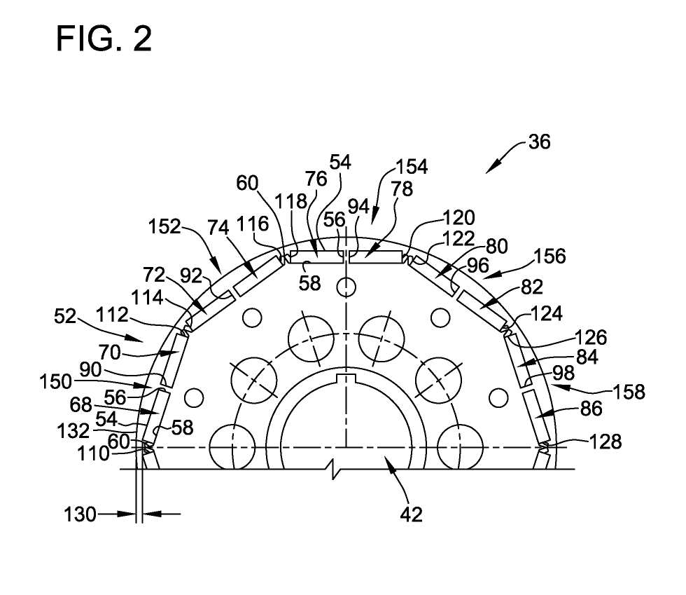

FIG. 2 is a front cutaway view of an exemplary embodiment of rotor core 36 (shown in FIG. 1) that may be included within electric motor 10 (shown in FIG. 1). In the exemplary embodiment, rotatable assembly 20 includes rotor core 36 and shaft 38 (shown in FIG. 1). Rotatable assembly 20 may also be referred to as an interior permanent magnet rotor. Examples of motors that may include interior permanent magnet rotors include, but are not limited to, electronically commutated motors (ECMs). ECMs may include, but are not limited to, brushless direct current (BLDC) motors, brushless alternating current (BLAC) motors, and synchronous reluctance motors.

Rotor core 36 includes a shaft opening 42 having a diameter corresponding to a diameter of shaft 38. Rotor core 36 and shaft 38 are concentric and configured to rotate about axis of rotation 34 (shown in FIG. 1). In the exemplary embodiment, rotor core 36 includes a plurality of laminations that are either interlocked or loose. In an alternative embodiment, rotor core 36 is a solid core. For example, rotor core 36 may be formed using a sintering process from a soft magnetic composite (SMC) material, a soft magnetic alloy (SMA) material, and/or a powdered ferrite material.

Rotor core 36 further includes a plurality of inner walls that define a plurality of permanent magnet openings 52. For example, a first inner wall 54, a second inner wall 56, a third inner wall 58, and a fourth inner wall 60 define a first permanent magnet opening 68 of the plurality of permanent magnet openings 52. In the exemplary embodiment, permanent magnet openings 52 further include a second permanent magnet opening 70, a third permanent magnet opening 72, a fourth permanent magnet opening 74, a fifth permanent magnet opening 76, a sixth permanent magnet opening 78, a seventh permanent magnet opening 80, an eighth permanent magnet opening 82, a ninth permanent magnet opening 84, a tenth permanent magnet opening 86, an eleventh permanent magnet opening (not shown in FIG. 2), a twelfth permanent magnet opening (not shown in FIG. 2), a thirteenth permanent magnet opening (not shown in FIG. 2), a fourteenth permanent magnet opening (not shown in FIG. 2), a fifteenth permanent magnet opening (not shown in FIG. 2), a sixteenth permanent magnet opening (not shown in FIG. 2), a seventeenth permanent magnet opening (not shown in FIG. 2), an eighteenth permanent magnet opening (not shown in FIG. 2), a nineteenth permanent magnet opening (not shown in FIG. 2), and a twentieth permanent magnet opening (not shown in FIG. 2).

In the exemplary embodiment, a first portion of rotor core material, referred to herein as a first bridge 90, is defined between first permanent magnet opening 68 and second permanent magnet opening 70. More specifically, first bridge 90 is a portion of rotor core material positioned between second inner wall 56 of first permanent magnet opening 68 and fourth inner wall 60 of second permanent magnet opening 70. Similarly, in the exemplary embodiment, a second portion of rotor core material, referred to herein as a second bridge 92, is positioned between third permanent magnet opening 72 and fourth permanent magnet opening 74. In the exemplary embodiment, rotor core 36 also includes a third bridge 94, a fourth bridge 96, a fifth bridge 98, a sixth bridge (not shown in FIG. 2), a seventh bridge (not shown in FIG. 2), an eighth bridge (not shown in FIG. 2), a ninth bridge (not shown in FIG. 2), and a tenth bridge (not shown in FIG. 2).

The permanent magnet openings 52 extend from first end 12 (shown in FIG. 1), through rotor core 36, to second end 14 (shown in FIG. 1). Each of the permanent magnet openings 52 is configured to receive one or more permanent magnets. In the exemplary embodiment, the permanent magnets extend at least partially through opening 52 from first end 12 to second end 14 of rotor core 36. For example, a first permanent magnet 110 is positioned within first permanent magnet opening 68, a second permanent magnet 112 is positioned within second permanent magnet opening 70, a third permanent magnet 114 is positioned within third permanent magnet opening 72, a fourth permanent magnet 116 is positioned within fourth permanent magnet opening 74, a fifth permanent magnet 118 is positioned within fifth permanent magnet opening 76, a sixth permanent magnet 120 is positioned within sixth permanent magnet opening 78, a seventh permanent magnet 122 is positioned within seventh permanent magnet opening 80, an eighth permanent magnet 124 is positioned within eighth permanent magnet opening 82, a ninth permanent magnet 126 is positioned within ninth permanent magnet opening 84, and a tenth permanent magnet 128 is positioned within tenth permanent magnet opening 86. In an alternative embodiment, multiple permanent magnets are positioned within each permanent magnet opening. For example, a first permanent magnet may be positioned within a permanent magnet opening and extend from first end 12 to a point between first end 12 and second end 14 and a second permanent magnet may be positioned within the permanent magnet opening and extend from second end 14 to the point between first end 12 and second end 14.

The permanent magnets are fabricated as relatively thin segments of permanent magnet material, each providing a substantially constant flux field. The permanent magnets are magnetized to be polarized radially in relation to the rotor core 36 with adjacent magnets making up the same pole having the same polarity. The polarity of adjacent poles are alternately polarized. In the exemplary embodiment, openings 52 are generally rectangular openings. Although described as rectangular, openings 52 may have any suitable shape, including, but not limited to a shape substantially corresponding to the shape of the permanent magnet, that allows rotatable assembly 20 to function as described herein.

The bridges within rotor core 36, for example, bridges 90, 92, 94, 96, and 98, provide structural support to rotor core 36, therefore, strengthening rotor core 36. As a distance 130 between first inner wall 54 and an outer surface 132 of rotor core 36 decreases, the amount of rotor core material that holds permanent magnet 110 within opening 68 also decreases. As a diameter 132 of rotor core 36 increases, forces on the permanent magnets also increase at a given rotational speed. If distance 130 is not large enough, the forces on the permanent magnets may exceed the strength of the rotor core material. The bridges facilitate positioning the permanent magnets closer to outer surface 132 than if no bridges were present without reducing the strength of rotor core 36 to a level where rotor core 36 cannot withstand forces present during high speed operation of motor 10. Furthermore, by generating a rotor pole using multiple smaller permanent magnets rather than a single larger permanent magnet, eddy current losses of the permanent magnets are reduced.

While permanent magnets 110, 112, 114, 116, 118, 120, 122, 124, 126, and 128 in rotor core 36 are illustrated for purposes of disclosure, it is understood that interior permanent magnet rotors are known, and that at least a portion of the embodiments described herein are directed to improvements in the construction of rotatable assembly 20 as well as to the construction of stationary assembly 18 (shown in FIG. 1) to reduce cogging torque and noise.

In the exemplary embodiment, rotor core 36 includes a plurality of rotor poles, for example, ten rotor poles. Each rotor pole includes multiple permanent magnets. For example, a first rotor pole 150 is produced by first permanent magnet 110 and second permanent magnet 112, a second rotor pole 152 is produced by third permanent magnet 114 and fourth permanent magnet 116, a third rotor pole 154 is produced by fifth permanent magnet 118 and sixth permanent magnet 120, a fourth rotor pole 156 is produced by seventh permanent magnet 122 and eighth permanent magnet 124, and a fifth rotor pole 158 is produced by ninth permanent magnet 126 and tenth permanent magnet 128. Although described as including ten poles, rotor core 36 may include any number of poles that allows motor 10 to function as described herein. Furthermore, although described as each being produced by two permanent magnets, each of the plurality of rotor poles 148 may be produced by three permanent magnets, four permanent magnets, or any other suitable number of permanent magnets that allows electric motor 10 to function as described herein.

In the exemplary embodiment, winding stages 32 of stator core 28 are energized in a temporal sequence and a pattern of ten magnetic poles, matching the rotor pole count, is established that will provide a radial magnetic field which moves clockwise or counterclockwise around stator core 28 depending on the preselected sequence or order in which winding stages 32 are energized. Alternatively, winding stages 32 may be energized to produce other patterns, for example, non-torque producing patterns that may include other numbers of magnetic poles. This moving magnetic field intersects with the flux field created by permanent magnets 110, 112, 114, 116, 118, 120, 122, 124, 126, and 128 to cause rotatable assembly 20 to rotate relative to stator core 28 in the desired direction to develop a torque which is a direct function of the intensities or strengths of the magnetic fields. Although stator teeth are sometimes referred to as “poles” by some practitioners, as referred to herein, stator teeth are included within stator core 28 and stator poles are generated by energizing winding stages 32 positioned around the stator teeth. While there are twelve teeth and windings shown in the figures described herein, the motors may be operated by energizing only a subset of the windings. Therefore a motor may be referred to as having an unequal number of teeth and poles.

Winding stages 32 are commutated without brushes by sensing the rotational position of rotatable assembly 20 as it rotates within stator core 28 and utilizing electrical signals generated as a function of the rotational position of rotatable assembly 20 sequentially to apply a voltage to each of winding stages 32 in different preselected orders or sequences that determine the direction of the rotation of rotatable assembly 20. Position sensing may be accomplished by a position-detecting circuit responsive to the back electromotive force (EMF) to provide a simulated signal indicative of the rotational position of rotatable assembly 20 to control the timed sequential application of voltage to winding stages 32 of stationary assembly 18. Other means of position sensing may also be used.

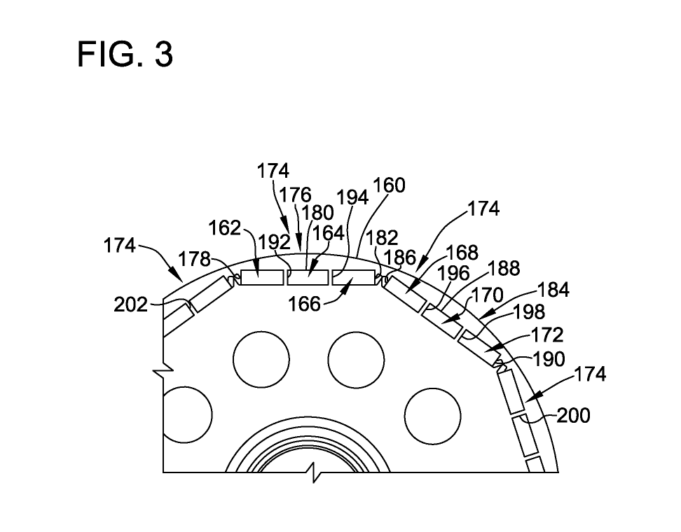

FIG. 3 is a front view of an alternative embodiment of a rotor core 160 that may be included within electric motor 10 (shown in FIG. 1). In the alternative embodiment, rotor core 160 includes a plurality of permanent magnet openings defined therein. For example, rotor core 160 may include a first permanent magnet opening 162, a second permanent magnet opening 164, a third permanent magnet opening 166, a fourth permanent magnet opening 168, a fifth permanent magnet opening 170, a sixth permanent magnet opening 172, and so on about a perimeter of rotor core 160. Furthermore, each of a plurality of rotor poles 174 produced by a plurality of permanent magnets included within rotor core 160 is produced by three permanent magnets. For example, a first rotor pole 176 is produced by a first permanent magnet 178, a second permanent magnet 180, and a third permanent magnet 182. Furthermore, a second rotor pole 184 is produced by a fourth permanent magnet 186, a fifth permanent magnet 188, and a sixth permanent magnet 190. Moreover, additional rotor poles are produced by the permanent magnets positioned within rotor core 160.

Rotor core 160 also includes a first portion of rotor core material, referred to herein as a first bridge 192. First bridge 192 is positioned between first permanent magnet opening 162 and second permanent magnet opening 164. Similarly, rotor core 160 includes a second portion of rotor core material, referred to herein as a second bridge 194, positioned between second permanent magnet opening 164 and third permanent magnet opening 166. In the alternative embodiment, rotor core 160 also includes a third bridge 196, a fourth bridge 198, a fifth bridge 200, and so on about rotor core 160. In the illustrated embodiment, rotor core 160 includes twenty bridges, including a twentieth bridge 202. As described above with respect to bridges 90, 92, 94, 96, and 98, bridges 192, 194, 196, 198, 200, and 202 provide structural support to rotor core 160, therefore, strengthening rotor core 160. Bridges 192, 194, 196, 198, 200, and 202 also facilitate including smaller permanent magnets within rotor core 160, which reduces eddy current losses of the permanent magnets included within rotor core 160 when compared to eddy current losses of larger permanent magnets.

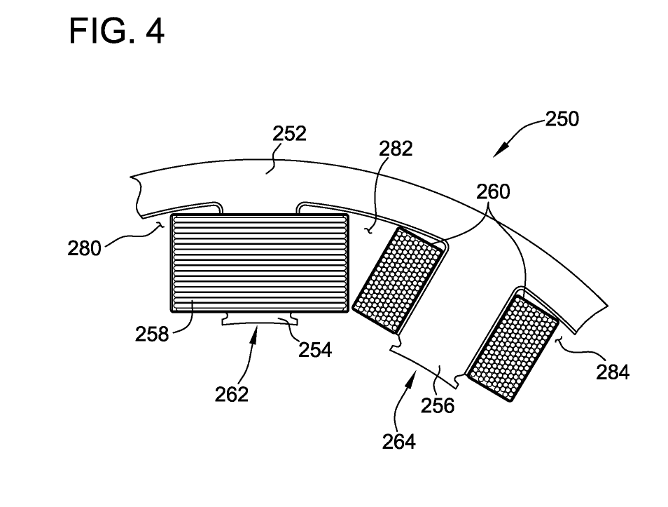

FIG. 4 is a detailed view of a portion of a known stationary assembly 250, also referred to herein as a stator, that might be utilized in motor 10 (shown in FIG. 1). Stator 250 includes an open slot stator core 252. The illustrated portion of stator core 252 includes a plurality of stator teeth, for example, a first stator tooth 254 and a second stator tooth 256 and those skilled in the art understand that stator core 252 includes a plurality of stator teeth spaced about the perimeter of stator core 252. Stator 250 also includes a plurality of windings, for example, a first winding 258 and a second winding 260. When operating, first stator tooth 254 and first winding 258 generate a first pole 262 and second stator tooth 256 and second winding 260 generate a magnetically opposite second pole 264. For ease of understanding, winding 260 is shown in a cutaway view, which provides a view of stator tooth 256. Each stator tooth is substantially surrounded by an associated winding. However, in an alternate form, a winding may be positioned around every other tooth (i.e., a tooth that does not include a winding is positioned between each tooth that includes a winding) and alternating teeth may be differently shaped. Stator tooth 254 is therefore substantially surrounded by winding 258. Stator core 252 is an open slot stator core as slots 280, 282, and 284 between adjacent stator teeth, for example, slot 282, defined between stator teeth 254 and 256, are easily accessible for the insertion of windings 258 and 260. However, the open area associated with such open stator slots can lead to the noise and cogging torque explained above.

The motors and components described with respect to FIGS. 1-4 are merely examples that may be utilized with the embodiments described below and therefore it should be understood that the described embodiments are not limited to the examples of FIGS. 1-4. For example, permanent magnet rotors may be incorporated in various electric machines. Rather, the embodiments are directed, in at least one aspect, to reduce the manufacturing cost of such machines as well as make effective use of material, for example, to achieve a very high fill of copper in the stator slots while at the same time minimizing or eliminating cogging torque and/or radial forces on the rotor that can normally occur in permanent magnet machines.

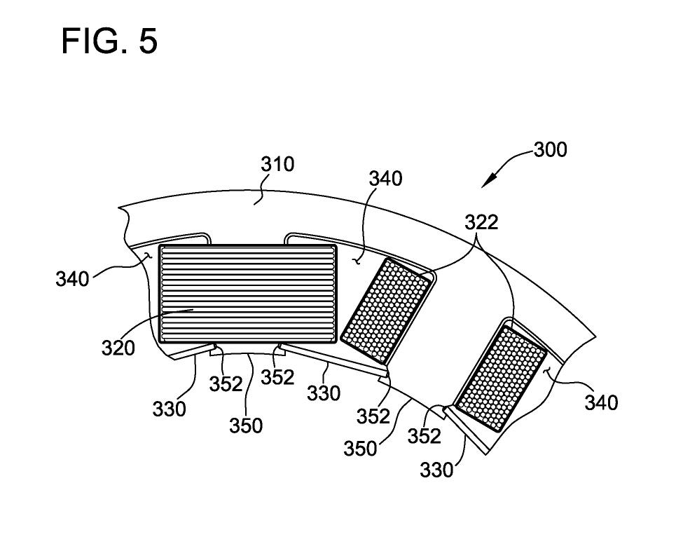

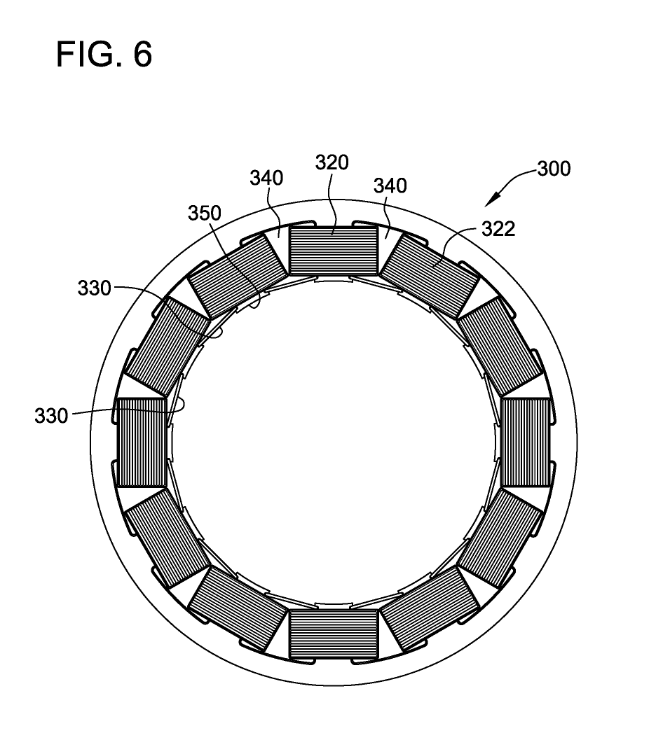

FIG. 5 is a detailed view of a stator 300 according to one embodiment incorporating a stator core 310 and windings 320, 322. Stator 300 addresses at least a portion of the shortcomings described above with respect to stator 250 as stator 300 incorporates a plurality of wedges 330 each positioned between the individual teeth of stator 300. FIG. 5 is a cutaway view for providing detail. Conversely, FIG. 6 is a front view showing entire stator 300 and plurality of wedges 330, with one wedge 330 located in each slot 340. In addition to the magnetic properties described below, wedges 330 operate in place of more standard insulating material to hold the windings 320, 322 in their respective slots. In the illustrated embodiment, each stator tooth 350 is formed to include an indentation 352 on each side of tooth 350. Wedge 350 is sized such that it may be slid into corresponding indentations 352 of adjacent stator teeth 350. As described below, the use of wedges 330 allows the use of an open slot stator core, while achieving some of the performance benefits of a semi-closed stator slot.

In some embodiments, wedge 330 is fabricated utilizing a semi-magnetic material. In addition to maintaining placement of windings 320, 322, the semi-magnetic properties of wedge 330 reduce pulsations and vibrations in permanent magnet motors. Further, efficiency, and motor generated back EMF (or voltage) is increased, resulting in a quieter and more efficient running motor. In one embodiment, wedges 330 are fabricated using a woven structure that is cured using a resin impregnated with a ferrous material, for example, iron powder. In another embodiment, shredded fiberglass, resin and ferrous material are extruded and cured to form wedges 330. FIG. 6 illustrates stator 300 in its entirety, showing all windings and wedges 330 placed in slots 340 between each stator tooth 350.

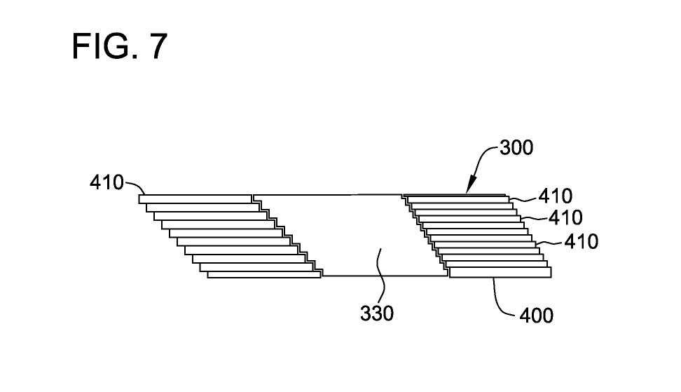

FIG. 7 is a cross-sectional view of a portion of stator 300. In the illustrated embodiment, stator 300 is a skewed stack stator. Specifically, stator 300 includes a stator core 400 formed using a stack of thin laminations 410. Laminations 410 are punched individually and generally have the same pattern for the individual teeth and slots. In a skewed stack stator core such as core 400 each lamination 410 is offset from adjacent laminations 410. This offset is depicted in FIG. 7.

In typical production of generators and motors, a skew angle corresponding to approximately one stator tooth width is used. Therefore the resultant skew angle is a function of the number of stator teeth in the machine divided into 360 degrees. For example, a 36 tooth stator will yield a radial skew of 10 degrees, and a 48 tooth stator will yield a radial skew of 7.5 degrees.

The embodiments described herein incorporate a stator skew calculated such that, at a specified angle, a rotor pole will align itself to a stator pole tooth. This number is calculated based on the pole counts of the rotor and the tooth count of the stator. As an example, a 12 tooth stator and a 10 pole rotor are considered. In this example, the optimum skew is a function of the least common multiple of these numbers. The least common multiple for a 12 slot stator and a 10 pole rotor is 60, by which the 360 degrees of motor rotation is divided to provide a radial skew of 6.0 degrees.

In some embodiments, each individual lamination of the stator stack is skewed an amount that is substantially equal to the number of stator laminations divided by the total radial skew. For example, for a 50 lamination stator stack, each successive lamination must be skewed 0.12 degrees to achieve the radial skew of 6.0 degrees. In other embodiments, subsets of the individual laminations may be aligned with one another. For example, for the 50 lamination stator stack example, successive five lamination subsets can each be skewed 0.6 degrees from the adjacent subsets, with ten sets of five lamination subsets making up the 6.0 degree radial skew described above.

To further illustrate, a 20 pole rotor and a 24 tooth stator are considered. The least common multiple of 20 and 24 is 120. The 360 degrees of motor rotation is divided by the least common multiple (i.e., 120) to determine the optimum radial skew (i.e., 3.0 degrees). Each individual lamination of the stator stack is skewed an amount that is substantially equal to the number of stator laminations divided by the total radial skew. For example, for a 50 lamination stator stack, each successive lamination is skewed radially 0.06 degrees to achieve the 3.0 degrees of radial skew.

While semi-magnetic material has been utilized in the stators of machines that do not incorporate permanent magnet rotors, such machines have included 24-108 stator slots. These machines have also incorporated skewed and non-skewed stator stacks.

In contrast, at least some of the embodiments described herein include a stator with a total radial skew of about six degrees and semi-magnetic wedges that are shaped similarly to the skew of the stator stack. In a specific embodiment, a 12 slot skewed stack stator core is contemplated for use with a 10 pole permanent magnet rotor. Such construction results in partial closure of the stator slot from a magnetic standpoint, allows for the ease of construction similar to straight stack stators, and provides a mechanical device that also operates to maintain positioning of windings within the respective stator slots.

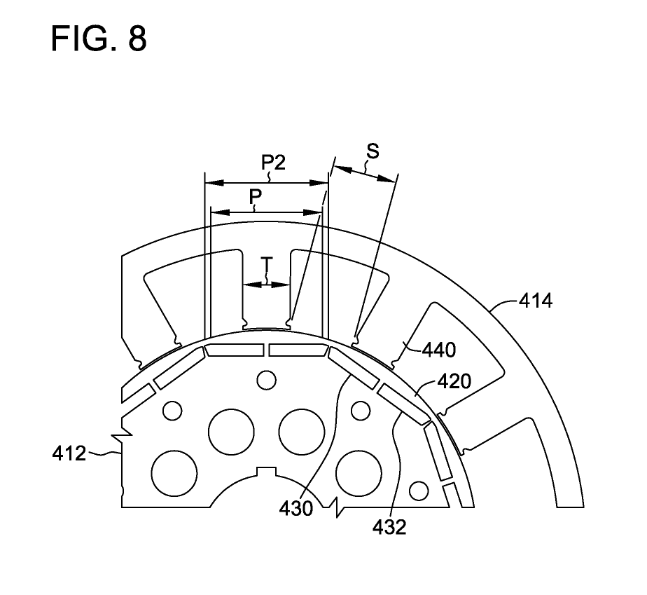

The above described embodiments relate to a skewing of stator stacks and insertion of magnetic wedges between stator teeth. The embodiments provide reductions in cogging torque and motor noise while still allowing for the ease of construction an open slot stator provides. Such embodiments may be incorporated in combination with a rotor 412 described with respect to FIG. 8 or may be incorporated with other permanent magnet rotors, including both exterior and interior permanent magnet rotors.

As mentioned, an embodiment of a portion of an interior permanent magnet rotor 412 is shown in FIG. 8. Rotor 412 is shown in an operating position with respect to a stator 414. Stator 414 may be any one of stator 250 (shown in FIG. 4) and stator 300 (shown in FIGS. 5 and 6), and for example, may or may not incorporate the skewing configuration described above. Stator 414 is illustrated without windings for clarity. Rotor 412 also incorporates features that provide for a reduction in cogging torque and may be incorporated into a motor that incorporates the stator configurations described above, or in motors that incorporate other stator configurations. Referring specifically to FIG. 8, a small amount of ferromagnetic material 420 that covers magnets 430, 432, initially provided for retention, can also be used to concentrate and steer the magnet flux to a stator tooth 440 that does not incorporate tooth extensions for closing stator slots.

More specifically, ferromagnetic material 420 on top of magnets 430 and 432 gathers and/or channels the flux from the outer surface of a magnet and concentrates it to where the relatively narrow, extension-less stator tooth 440 is situated. Ferromagnetic material 420 reduces cogging torque, which can easily be large with an open slot stator such as stator 414 (shown in FIG. 8). Furthermore, cogging torque may be further reduced by adjusting the magnet pole arc width to produce a cogging torque null.

Cogging torque is present for most rotor magnet size and width geometries. The amount of cogging torque in this configuration varies with the relationship of the rotor magnet pole width P2, the stator tooth width T, and the stator slot opening width S. The rotor magnetic pole width P2 includes not only the magnet width P, but also the dimensions of the magnetic and non magnetic portions between poles. As the geometry is changed in small increments there are relationships where the cogging torque reduces to very low values, at or near zero. By using the magnetic pole width that result in these optimum or null points in the design of the machine, cogging torque can be reduced to near zero. Referring to FIG. 8, as the values for “P” and “P2” are adjusted for given values of “T” and “S”, the torsional cogging torque magnitude will vary.

As such, the cogging torque can be controlled based on rotor magnetic pole dimensions. The reduction in cogging torque facilitates using the open slot stator configuration and capitalizing on the associated manufacturing benefits of an open slot stator. More specifically, the coils around single teeth can be individually and/or bobbin wound, perfectly layered, and even use rectangular wire to achieve very high slot fill rates. The pre-fabricated coils are then simply slid over the stator teeth. As described above, wedges, also referred to as magnetic top sticks, can be used to maintain a position of the coils if desired.

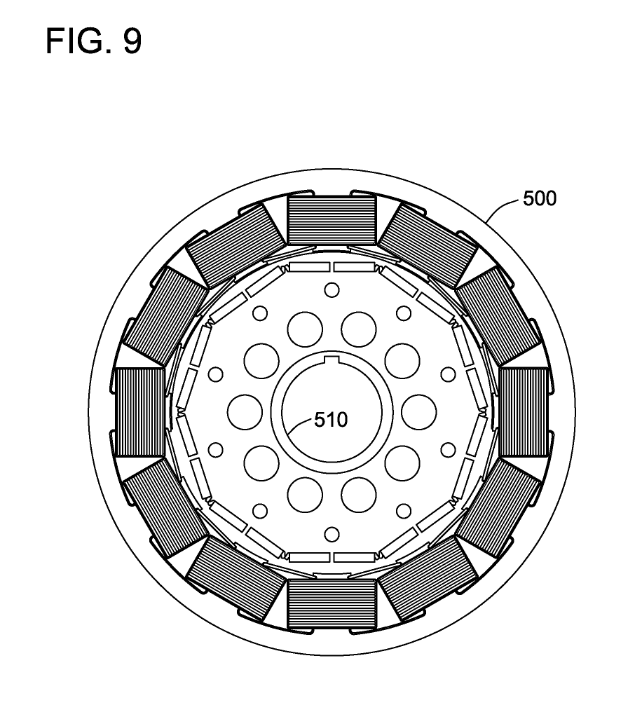

FIG. 9 is a front view of a twelve tooth stator 500 incorporating one or more of the above described embodiments and a ten pole rotor 510 positioned with respect to stator 500 and incorporating one or more of the above described embodiments. Stator 500 may also be referred to as a twelve slot stator as the number of stator slots in a stator core is equal to the number of stator teeth.

While the embodiments described herein are described with respect to motors in which a stator surrounds a permanent magnet rotor, embodiments are contemplated in which an “inside-out” motor incorporates one or more of the improvements described herein. Inside-out motors refer to motors where a stationary stator is surrounded by a rotating rotor. Further, the embodiments are applicable to any permanent magnet rotating machine.

While the invention has been described in terms of various specific embodiments, those skilled in the art will recognize that the invention can be practiced with modification within the spirit and scope of the claims.

What is claimed is:

1. A method for manufacturing an interior permanent magnet motor, said method comprising:
providing a plurality of permanent magnets;
fabricating a ferromagnetic rotor core configured to accept the permanent magnets therein such that the ferromagnetic material utilized to retain the permanent magnets within the rotor core operates to concentrate and steer the flux from one or more of the permanent magnets to a stator tooth; and
positioning the rotor core with the permanent magnets therein with respect to a wound, open slot stator core.

2. The method according to claim 1 wherein fabricating a ferromagnetic rotor core comprises fabricating a ferromagnetic rotor core wherein the ferromagnetic material retaining the permanent magnets has a higher saturation flux density than a working flux density of the permanent magnets.

3. The method according to claim 1 wherein fabricating a ferromagnetic rotor core comprises fabricating a ferromagnetic rotor core wherein the ferromagnetic material retaining the permanent magnet is operable to:
gather the flux from an outer surface of one or more of the permanent magnets; and
concentrate the flux to where a stator tooth of the stator core is situated.

4. The method according to claim 1 wherein fabricating a ferromagnetic rotor core comprises fabricating a ferromagnetic rotor core wherein the ferromagnetic material retaining the permanent magnet is operable to adjust a magnet pole arc width to produce a cogging torque null with respect to a proximate stator tooth.

5. The method according to claim 1 further comprising installing a wedge of semi-magnetic material in each slot of the wound, open slot stator core.

6. The method according to claim 1 further comprising fabricating a stator with a total radial skew equal to 360 divided by the least common multiple of the number of poles in the fabricated rotor core and the number of stator teeth.

7. The method according to claim 7 further comprising at least one of:
skewing each individual stator lamination of the stator core by an amount that is substantially equal to the number of stator laminations divided by the total radial skew; and
aligning subsets of the individual stator laminations with one another and skewing each subset of the stator laminations by an amount that is substantially equal to the number of stator lamination subsets divided by the total radial skew.

8. A motor comprising:
a shaft;
a permanent magnet rotor comprising:
a plurality of permanent magnets;
a rotor core configured to accept the permanent magnets therein defining a number of rotor poles, said rotor core comprising a ferromagnetic material, said ferromagnetic material operable to retain said magnets within said rotor core; and
a central bore through which said shaft extends; and
a stator assembly comprising an open slot stator core comprising a plurality of slots and teeth, said ferromagnetic material within said rotor core configured to concentrate and steer the flux from one or more of said magnets to a said tooth of said stator assembly proximate said ferromagnetic material.

9. The motor according to claim 8 wherein said ferromagnetic material retaining said permanent magnets has a higher saturation flux density than a working flux density of said permanent magnets.

10. The motor according to claim 8 wherein said ferromagnetic material retaining said permanent magnets is operable to:
gather the flux from an outer surface of one or more of said permanent magnets; and
concentrate the flux to where a respective said tooth of said stator assembly is situated.

11. The motor according to claim 8 wherein said ferromagnetic material is configured to adjust a magnet pole arc width to produce a cogging torque null with respect to a proximate said tooth of said stator assembly.

12. The motor according to claim 8 wherein said stator core of said stator assembly comprises a skew of the stator core based on a least common multiple of the number of rotor poles and the number of stator teeth.

13. The motor according to claim 12 wherein said stator core comprises a total radial skew equal to 360 divided by the least common multiple of the number of rotor poles and the number of stator teeth.

14. The motor according to claim 13 wherein said stator core comprises at least one of:
a plurality of individual stator laminations each successively skewed by an amount that is substantially equal to the number of said stator laminations divided by the total radial skew; and
a plurality of subsets of individual stator laminations, each subset of the stator laminations skewed with respect to an adjacent said subset by an amount that is substantially equal to the number of said stator lamination subsets divided by the total radial skew.

15. The motor according to claim 8 further comprising a semi-magnetic wedge in each said slot, each said wedge between adjacent said teeth, and located proximate said rotor core, each said wedge operable to maintain a position of said windings.

16. The motor according to claim 15 wherein said wedges comprise a resin impregnated with ferrous material.

17. An interior permanent magnet rotor comprising:
a plurality of permanent magnets; and
a rotor core configured to accept said permanent magnets therein, thereby defining a number of rotor poles, said rotor core comprising a ferromagnetic material, said ferromagnetic material operable to retain said permanent magnets within said rotor core and concentrate and steer flux from one or more of said permanent magnets to a tooth of a stator assembly.

18. The interior permanent magnet rotor according to claim 17 wherein said ferromagnetic material retaining said permanent magnets has a higher saturation flux density than a working flux density of said permanent magnets.

19. The interior permanent magnet rotor according to claim 17 wherein said ferromagnetic material retaining said permanent magnets is operable to:
gather the flux from an outer surface of one or more of said permanent magnets; and
concentrate the flux to where a respective tooth of a stator assembly is situated.

20. The interior permanent magnet rotor according to claim 17 wherein said ferromagnetic material is configured to adjust a magnet pole arc width to produce a cogging torque null with respect to a proximate tooth of a stator assembly.
